(19) United States
(12) Patent Application Publication
(10) Pub. No.: US 2015/0136665 A1
(43) Pub. Date: May 21, 2015

(54) Water Filter with Electrical Conductivity Meter

(71) Applicants: Erez Mazor, Givat Avni (IL); Ronen Aharon Cohen, Moza Elit (IL)

(72) Inventors: Erez Mazor, Givat Avni (IL); Ronen Aharon Cohen, Moza Elit (IL)

(21) Appl. No.: 14/082,218

(22) Filed: Nov. 18, 2013

(51) Int. Cl. C02F 1/00

(52) U.S. Cl. CPC C02F 1/003; C02F 2209/05; C02F 2103/04
USPC 210/85

(57) ABSTRACT

The present invention relates to water filter comprises an electrical conductivity meter and a filter cartridge core for water treatment comprises one or more of the following group: filter gauze, carbonate filter, ceramic filter and Silifos balls. In addition, the invention relates to a filter cartridge core for water treatment which including one or more of the following group: filter gauze, carbonate filter, ceramic filter and Silifos balls which intended to be inserted in a filter housing that combines an electrical conductivity meter.

### FIELD OF THE INVENTION

The present invention relates to a water filter which includes an electrical conductivity meter which aimed to check the water quality in real time.

### BACKGROUND OF THE INVENTION

Water filtering is a process of cleaning water from materials, chemicals and contaminations. The most common target of water filtering is to make it suitable for drinking. Water filters are usually installed in houses in order to make the running water suitable for drinking. However, the people who consume the filtering water are not certain whether the filters that are installed on the main pipe of their houses indeed clean the water properly. The present invention provides a good and efficient solution for this problem.

### LIST OF DRAWINGS

The intention of the drawings attached to the application is not to limit the scope of the invention and its application. The drawings are intended only to to illustrate the invention and they constitute only one of its many possible implementations.

FIG. 1 describes a front sectional view of the water filter (1) that includes a housing (2), an electric conductivity meter (3) and a filter cartridge core (4).

FIG. 2 describes a perspective sectional view of the housing (2) that includes a base (21), a cover (22), internal chamber (23), water inlet (11) and water outlet (12).

FIG. 3 describes a perspective sectional view of the filter cartridge core (4) that includes a gauze filter (41), siliphos balls (43), ceramic filter (44) and carbonate filter (42).

FIG. 4 describes a perspective view of the electric conductivity meter (3).

FIG. 5 describes the upper part of the water filter (1) that includes the internal chamber (23) and the first internal chamber (231).

FIG. 6 describes the set (111) that comprises a water filter (1) and two external chambers (232) that are aimed to be installed in the inlet and outlet water (11) (12) or along the pipe near said inlet and outlet water (11) (12).

### THE INVENTION

The term “water filter” in this patent application relates to the filter that comprises housing with a filter cartridge core inside. The filter cartridge core comprises several filters.

The main object of the present invention is to provide a water filter that includes an electric conductivity meter (hereinafter “ECM”) and filter cartridge core (hereinafter “FCC”) that includes one or more of the following types of filters: Net filter, carbonate filter, antibacterial ceramic balls filter, and siliphos balls. Another object of the invention is to provide a FCC that consists of several filters. Another object of the invention is to provide such FCC that is also aimed to be inserted into the housing that includes the ECM.

The water filter (1) comprises a housing (2), an electric conductivity meter (ECM) (3) and a filter cartridge core (FCC) (4) that includes one or more of the following filters: gauze filter (41), carbonate filter (42), antibacterial ceramic balls filter (44), and siliphos balls (43).

The housing (2) can be designed in a shape of any other housing of standard water filters. The housing (2) includes a base (21) in which the FCC (4) is aimed to be inserted, a cover (22) which is aimed to close and seal the housing (2) and an internal chamber (23) which is aimed to contain the ECM (3).

The filter cartridge core (FCC) (4) comprises, as mentioned above, a gauze filter (41), carbonate filter (42), antibacterial ceramic balls filter (44) and siliphos balls (43). The structure and combination of such filters are known to any average professional expert in this field and therefore there is no need to describe them in details.

The gauze filter (41) is usually made of materials such as polypropylene and it is aimed to filter the water from floating solids, sand, rust and rough dirt. The carbonate filter (42) comprises a chamber that includes active carbonate which is aimed to remove organic materials and materials which cause bad smell and taste from the water. The siliphos balls (43) are commonly designed in the form of balls and they are aimed to prevent scale formation and thus protect plumbing and appliances that work with water. The siliphos is diluted in the water and prevents the minerals, which cause the scale, to sink in the plumbing and pipes, despite the fact that the water is sometimes hot and stand.

The ceramic filter (44) is combined of a chamber that includes inside ceramic balls such as SiO₂, Al₂O₃ and TiO₂. The ceramic filter (44) is aimed to filter micro-organism, poisoned minerals and basketries out of the water.

The ECM (3) is a known component and uses in many fields. In general, the ECM (3) comprises several anodes which inserted in a water pipe and a processor unit that measures the conductivity of the water between those anodes. The conductivity degree with the weighted degree of the water temperature indicates the amount of chemicals and dirt in water. The ECM (3) is inserted in the housing (2) near the water outlet, means, in the water after they flow through the FCC (4). As much as the water contains more dirt and contamination the water conductivity becomes lower, and vice versa. The ECM (3) includes a display panel (31) that shows the water conditions, that depends on the rate of chemicals and contamination in the water. When this rate exceeds a pre-determined rate, then warning is shown on the display panel (31) indicates that the water is not clean and has to be replaced, treat or clean the FCC (4). The display panel (31) can be an independent and separated unit, means, that it would be not integrally connected with the ECM (3). In such case, the ECM (3) and the display panel (31) both include a touch point and when there is a connection between these two touch points the results are shown on the display panel (31).

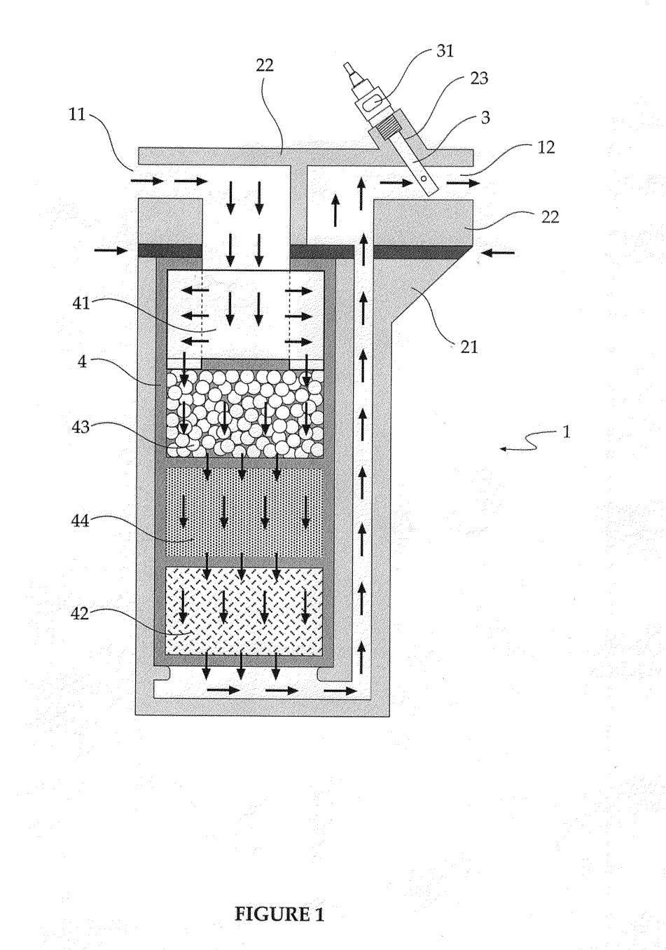

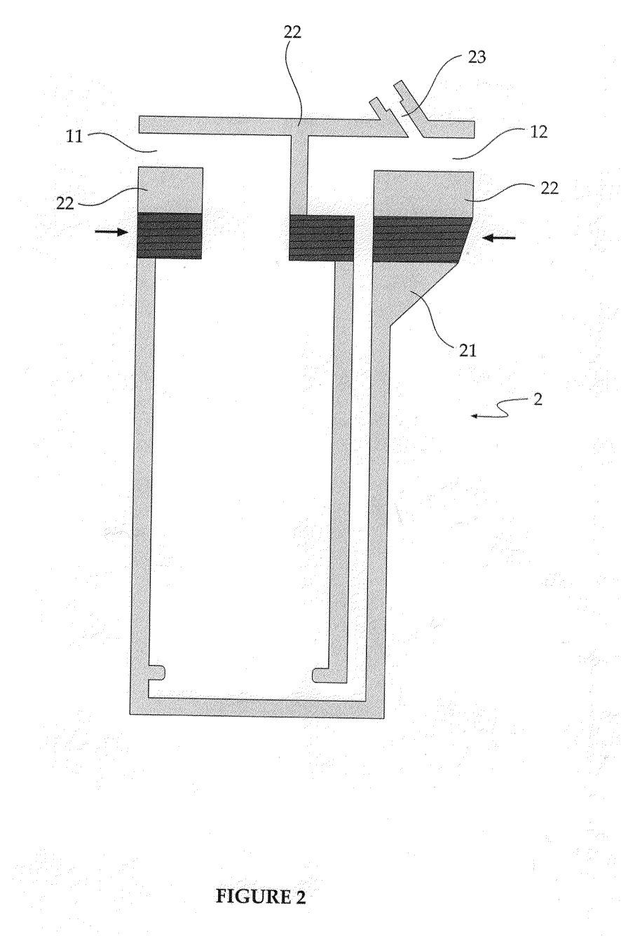

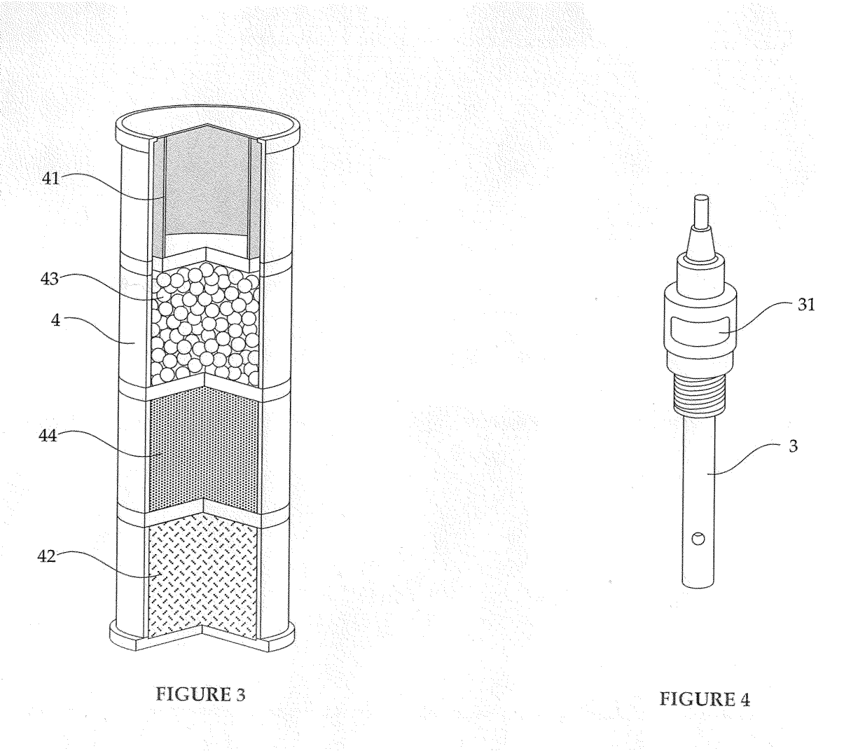

The water streaming path in the water filter (1) as it is shown in FIG. 1: the water stream through the inlet opening (11), the gauze filter (41), the siliphos balls (43) chamber, the ceramic filter (44), the carbonate filter (43) to the outlet opening (12) where the ECM (3) is inserted.

The innovation of the water filter (1) subject of the present invention lies in the fact that it consists the FCC (4) which capable of cleaning and purifying water out of chemicals and organic materials combined with monitoring and detection whether the ECM (4) serves its purpose, whether it is function, when it requires replacement, treatment or cleaning. In this way, the user purchases a single product unit which consists of filter housing, filter core and electrical conductivity with display panel which enabling the water cleaning and purification and also monitoring and controls such process in real time.

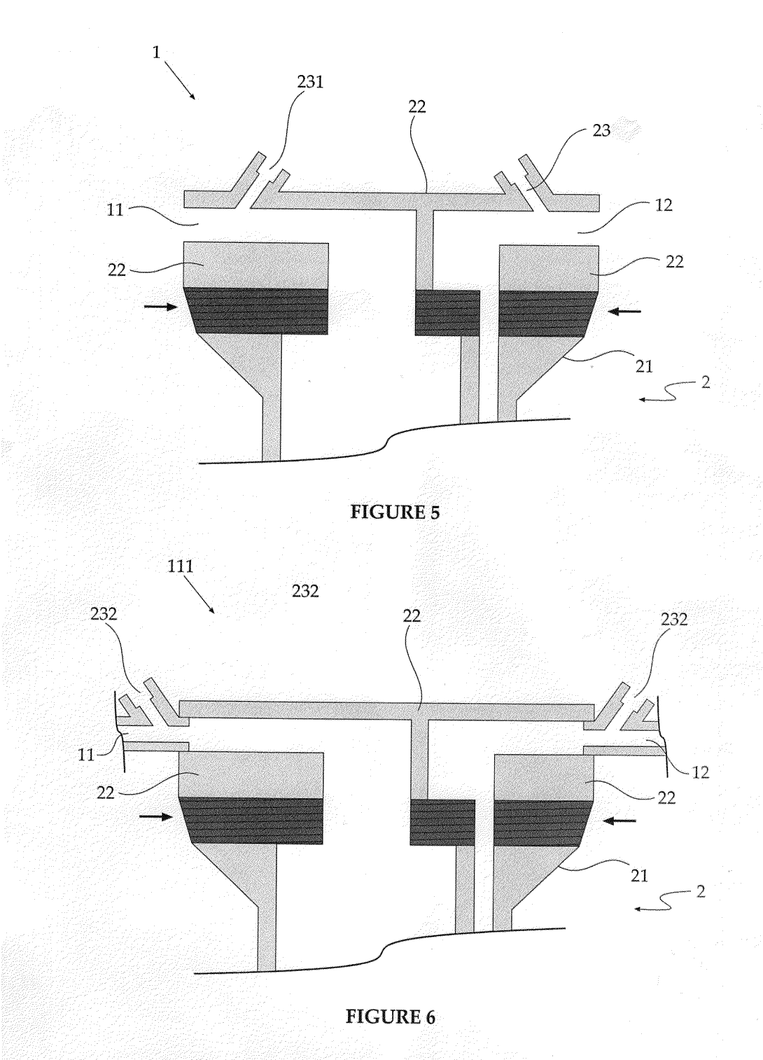

The second embodiment of the water filter (1) includes the housing (2) as described above and further it includes first internal chamber (231) with ECM (3) in the water inlet (11). The ECM (3) in the internal chamber (23) which is located near the water outlet (12) monitors the quality of the water after filtering and the ECM (3) in the first internal chamber (231) which is located near the water inlet (11) monitors the quality of the water before filtering and by that the user can realize the filtering efficiency. FIG. 5 describes the upper part of the water filter (1) of the second embodiment.

The third embodiment of the present invention relates to a set (111) that comprises a water filter (1) and one or two separable external chamber (232) which is aimed to be installed in the inlet and outlet water (11) (12) or along the pipe near said inlet and outlet water (11) (12). The ECM (3) is aimed to be o inserted into said external chambers (232). When the set (111) includes two separable external chambers (232) then the second one is aimed to be installed along the pipe (100) near the water inlet (11) or to the water inlet (11) itself. The installation of the second external chamber (232) along the pipe near the water inlet (11) or in said inlet (11) itself is done for realizing the filter efficiency. FIG. 6 describes the set (111) that comprises the water filter (1) with two separable external chambers (232) that are installed near the inlet and outlet water (11) (12).

The term “chemicals and dirt” in water as stated above and in this application refers to a wide variety of dirt, salts, blood, metals that percolating into groundwater from industrial sewage and so on. The water filter (1) subject matter of this invention relates to domestic and industrial usage and also to water systems in laboratories and machines.

What we claim is:

1. A water filter comprises an electrical conductivity meter and a filter cartridge core for water treatment comprises one or more of the following group: filter gauze, carbonate filter, ceramic filter and Silifos balls.

2. A filter cartridge core for water treatment which including one or more of the following group: filter gauze, carbonate filter, ceramic filter and Silifos balls which intended to be inserted in a filter housing that combines an electrical conductivity meter.

3. The water filter of claim 1 includes two electrical conductivity meters wherein one is located near the water inlet and the other is located near the water outlet.

4. A set comprises a water filter and one or two separable external chamber which are aimed to be installed in or near an inlet and outlet water of said water filter wherein said separable external chambers are aimed to receive an electrical conductivity meter.
